(19) United States
(12) Patent Application Publication
(10) Pub. No.: US 2023/0116476 A1
(43) Pub. Date: Apr. 13, 2023

(54) POWER ADAPTER ASSEMBLY STRUCTURE

(71) Applicant: Delta Electronics, Inc., Taoyuan City (TW)

(72) Inventors: Li-Yen Chang, Taoyuan City (TW); Chin-Chu Huang, Taoyuan City (TW)

(21) Appl. No.: 17/550,501

(22) Filed: Dec. 14, 2021

(30) Foreign Application Priority Data
Oct. 13, 2021 (CN) 202111193797.8

(51) Int. Cl. H01R 12/71; H01R 13/24

(52) U.S. Cl. CPC H01R 12/714; H01R 13/2407

(57) ABSTRACT

A power adapter assembly structure is disclosed and includes a circuit board, a socket and at least one elastic element. The socket is disposed adjacent to the circuit board. The circuit board and the socket are configured to collaboratively form at least one abutting surface and at least one fixing surface. The elastic element is connected between the circuit board and the socket, and includes a main body, a fixed portion and a hanging arm. The fixed portion and the hanging arm are disposed at two opposite ends of the main body, the fixed portion spatially corresponds to the fixing surface, and the hanging arm constantly abuts the abutting surface. A height is formed between the main body of the at least one elastic element and the at least one abutting surface, and less than a length of the hanging arm extended from the main body.

### FIELD OF THE INVENTION

The present disclosure relates to a power device, and more particularly to a power adapter assembly structure for simplifying the assembling procedure, realizing the automatic production, and avoiding the electrical interference at the same time.

### BACKGROUND OF THE INVENTION

In current daily life, power conversion modules are required to provide the power for many electronic device applications. The power conversion module mainly includes a combination of a socket and a circuit board. The socket is used to connect to the conductive plug of the power supply, and the circuit board is connected to the socket. In that, the power conversion modules are configured to convert electrical energy and provide the required power to the electronic devices. Moreover, in the power conversion modules, the socket and the circuit board are connected through the leading wires.

Since the leading wires have to be welded manually after the socket and the circuit board are assembled, the conventional power conversion assembly structure is not conducive to the realization of the automated production. On the other hand, it is not easy to control the length change and direction of the wire connection. Furthermore, it is easy to cause the electrical electromagnetic interference (EMI) or the radio frequency interference (RFI) due to the crossing of the leading wires.

Therefore, there is a need of providing a power adapter assembly structure to simplify the assembling procedure of the socket and the circuit board, realize the automatic production, avoid the EMI/RFI due to the crossed leading wires, and obviate the drawbacks encountered by the prior arts.

### SUMMARY OF THE INVENTION

An object of the present disclosure is to provide a power adapter assembly structure. By utilizing the elastic element to connect the socket and the circuit board, the assembling procedure is simplified, the automated production is realized, and the EMI/RFI caused by the crossed leading wires is avoided at the same time.

Another object of the present disclosure is to provide a power adapter assembly structure. With one-piece formed elastic element connected between a fixing surface and an abutting surface formed by the socket and the circuit board, a stable electronical connection of the socket and the circuit board is achieved. When the elastic element is pressed against the corresponding abutting surface constantly through the hanging arm thereof, the included angle between the hanging arm and the main body is for example an acute angle, so as to provide the elastic force and increase the structural strength. Since the hanging arm of the elastic element is pressed to constantly abut the corresponding abutting surface by the elastic force generated during assembling the socket and the circuit board, the assembling procedure of the socket and the circuit board is combined to realize the assembly structure of the socket, the circuit board and the elastic element by the automatic assembling equipment, and ensure the electrical connection between the socket and the circuit board.

A further object of the present disclosure is to provide a power adapter assembly structure. The elastic elements are configured to form the electrical connections between the socket and the circuit board, which are for example connected to the live wire, the neutral wire and the earth wire. Two elastic elements connected to the live wire and the neutral wire are led out from the rear side of the socket and arranged in parallel, so as to ensure that the minimum distance maintained between the two elastic elements meets the safety requirements for electrical clearance and creepage distance. In addition, the elastic element connected to the earth wire is led out from the lateral side of the socket to further ensure that the three elastic elements meet the safety requirements of electrical clearance and creepage distance. It avoids electrical EMI/RFI interference caused by crossed wires. On the other hand, since the electrical connections between the socket and the circuit board are realized through the elastic elements with structural strength, and integrated with the assembling procedure of the socket and the circuit board, it is more helpful to realize the assembly structure of the socket, the circuit board and the elastic elements by an automated production method. The assembling procedure is simplified, the production cost is reduced, and the competitiveness of the product is enhanced.

In accordance with an aspect of the present disclosure, a power adapter assembly structure is provided and includes a circuit board, a socket and at least one elastic element. The socket is disposed adjacent to the circuit board. The circuit board and the socket are configured to collaboratively form at least one abutting surface and at least one fixing surface. The at least one elastic element is connected between the circuit board and the socket, and includes a main body, a fixed portion and a hanging arm. The fixed portion and the hanging arm are disposed at two opposite ends of the main body, the fixed portion of the at least one elastic element spatially corresponds to the at least one fixing surface, and the hanging arm of the at least one elastic element constantly abuts the at least one abutting surface. A height is formed between the main body of the at least one elastic element and the at least one abutting surface, and the height is less than a length of the hanging arm extended from the main body.

In an embodiment, the power adapter assembly structure further includes a housing, wherein the circuit board and the socket are fastened on the housing, the at least one abutting surface is located at the socket, and the at least one fixing surface is located at the circuit board.

In an embodiment, the at least one abutting surface includes a live-wire abutting surface and a neutral-wire abutting surface located at a first side of the socket, and the at least one elastic element includes a first elastic element and a second elastic element, wherein the hanging arm of the first elastic element constantly abuts the live-wire abutting surface, and the hanging arm of the second elastic element constantly abuts against the neutral-wire abutting surface.

In an embodiment, the at least one fixing surface includes a live-wire fixing surface and a neutral-wire fixing surface located at a surface of the circuit board, and the fixed portion of the first elastic element is connected to the live-wire fixing surface, and the fixed portion of the second elastic element is connected to the neutral-wire fixing surface, wherein the first elastic element and the second elastic element are arranged parallel to each other.

In an embodiment, the at least one abutting surface further includes an earth-wire abutting surface located at a second side of the socket, and the at least one elastic element further includes a third elastic element, wherein the hanging arm of the third elastic element constantly abuts against the earth-wire abutting surface.

In an embodiment, the at least one fixing surface further includes an earth-wire fixing surface located at the surface of the circuit board, and the fixed portion of the third elastic element is connected to the earth-wire fixing surface.

In an embodiment, each of the live-wire abutting surface, the neutral-wire abutting surface and the earth-wire abutting surface is formed by a conductive metal sheet, wherein the socket further includes three conductive pins extended from the first side to a third side opposite to the first side, and the live-wire abutting surface, the neutral-wire abutting surface and the earth-wire abutting surface are electrically connected to the three conductive pins, respectively.

In an embodiment, the circuit board includes at least one perforation, and the fixed portion of the at least one elastic element is fixed on the circuit board through the perforation and electrically connected to the at least one fixing surface corresponding thereto.

In an embodiment, the power adapter assembly structure further includes a housing, wherein the circuit board and the socket are fastened on the housing, the at least one abutting surface is located at the circuit board, and the at least one fixing surface is located at the socket.

In an embodiment, the at least one abutting surface includes a live-wire abutting surface and a neutral-wire abutting surface located at a surface of the circuit board, and the at least one elastic element includes a first elastic element and a second elastic element, wherein the hanging arm of the first elastic element constantly abuts the live-wire abutting surface, and the hanging arm of the second elastic element constantly abuts against the neutral-wire abutting surface.

In an embodiment, the at least one fixing surface includes a live-wire fixing surface and a neutral-wire fixing surface located at a first side of the socket, and the fixed portion of the first elastic element is connected to the live-wire fixing surface, and the fixed portion of the second elastic element is connected to the neutral-wire fixing surface, wherein the first elastic element and the second elastic element are arranged parallel to each other.

In an embodiment, the at least one abutting surface further includes an earth-wire abutting surface located at the surface of the circuit board, and the at least one elastic element further includes a third elastic element, wherein the hanging arm of the third elastic element constantly abuts against the earth-wire abutting surface.

In an embodiment, the at least one fixing surface further includes an earth-wire fixing surface located at the first side of the socket, and the fixed portion of the third elastic element is connected to the earth-wire fixing surface.

In an embodiment, the main body of the third elastic element is extended from the first side to a second side, wherein the main body of the third elastic element, the main body of the second elastic element and the main body of the third elastic element are spaced apart from each other.

In an embodiment, the socket further includes three conductive pins extended from the first side to a third side opposite to the first side, and the live-wire fixing surface, the neutral-wire fixing surface and the earth-wire fixing surface are electrically connected to the three conductive pins, respectively.

In an embodiment, the hanging arm and the main body form an included angle, and the included angle is an acute angle.

In an embodiment, the at least one elastic element further includes an extension section connected to the hanging arm, and extended from the corresponding one of the at least one abutting surface toward the main body.

### BRIEF DESCRIPTION OF THE DRAWINGS

The above contents of the present disclosure will become more readily apparent to those ordinarily skilled in the art after reviewing the following detailed description and accompanying drawings, in which:

FIG. 1 is a perspective view illustrating a power adapter assembly structure according to a first embodiment of the present disclosure;

FIG. 2 is a perspective view illustrating the power adapter assembly structure according to the first embodiment of the present disclosure and taken from another perspective;

FIG. 3 is an exploded view illustrating the power adapter assembly structure according to the first embodiment of the present disclosure;

FIG. 4 is an exploded view illustrating the power adapter assembly structure according to the first embodiment of the present disclosure and taken from another perspective;

FIG. 5 is a vertical cross-sectional view illustrating the power adapter assembly structure according to the first embodiment of the present disclosure;

FIG. 6 is an exemplary structural view illustrating the elastic element of the power adapter assembly structure according to the first embodiment of the present disclosure;

FIG. 7 is a horizontal cross-sectional view illustrating the power adapter assembly structure according to the first embodiment of the present disclosure;

FIG. 8 is a perspective view illustrating a power adapter assembly structure according to a second embodiment of the present disclosure;

FIG. 9 is a perspective view illustrating the power adapter assembly structure according to the second embodiment of the present disclosure and taken from another perspective;

FIG. 10 is an exploded view illustrating the power adapter assembly structure according to the second embodiment of the present disclosure;

FIG. 11 is an exploded view illustrating the power adapter assembly structure according to the second embodiment of the present disclosure and taken from another perspective;

FIG. 12 is a vertical cross-sectional view illustrating the power adapter assembly structure according to the second embodiment of the present disclosure;

FIG. 13 is an exemplary structural view illustrating the elastic element of the power adapter assembly structure according to the second embodiment of the present disclosure; and

FIG. 14 is a horizontal cross-sectional view illustrating the power adapter assembly structure according to the first embodiment of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed. Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. When an element is referred to as being “connected,” or “coupled,” to another element, it can be directly connected or coupled to the other element or intervening elements may be present. Although the wide numerical ranges and parameters of the present disclosure are approximations, numerical values are set forth in the specific examples as precisely as possible. In addition, although the “first,” “second,” “third,” and the like terms in the claims be used to describe the various elements can be appreciated, these elements should not be limited by these terms, and these elements are described in the respective embodiments are used to express the different reference numerals, these terms are only used to distinguish one element from another element. For example, a first element could be termed a second element, and, similarly, a second element could be termed a first element, without departing from the scope of example embodiments. Besides, “and/or” and the like may be used herein for including any or all combinations of one or more of the associated listed items. Alternatively, the word “about” means within an acceptable standard error of ordinary skill in the art-recognized average. In addition to the operation/working examples, or unless otherwise specifically stated otherwise, in all cases, all of the numerical ranges, amounts, values and percentages, such as the number for the herein disclosed materials, time duration, temperature, operating conditions, the ratio of the amount, and the like, should be understood as the word “about” decorator. Accordingly, unless otherwise indicated, the numerical parameters of the present invention and scope of the appended patent proposed is to follow changes in the desired approximations. At least, the number of significant digits for each numerical parameter should at least be reported and explained by conventional rounding technique is applied. Herein, it can be expressed as a range between from one endpoint to the other or both endpoints. Unless otherwise specified, all ranges disclosed herein are inclusive.

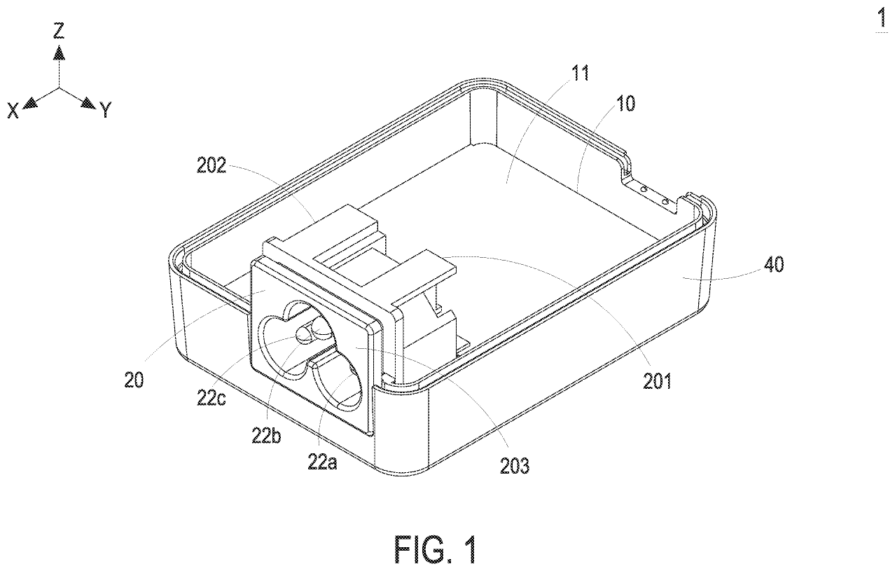

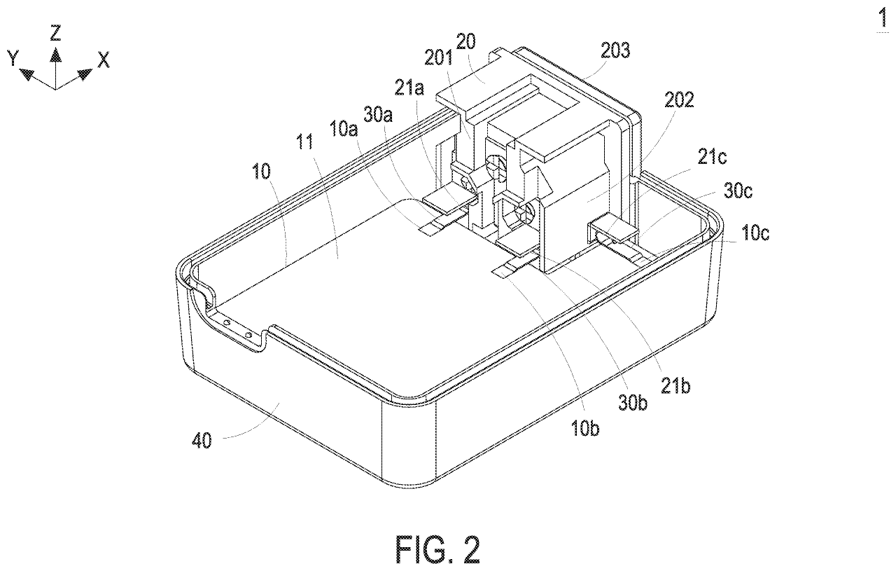

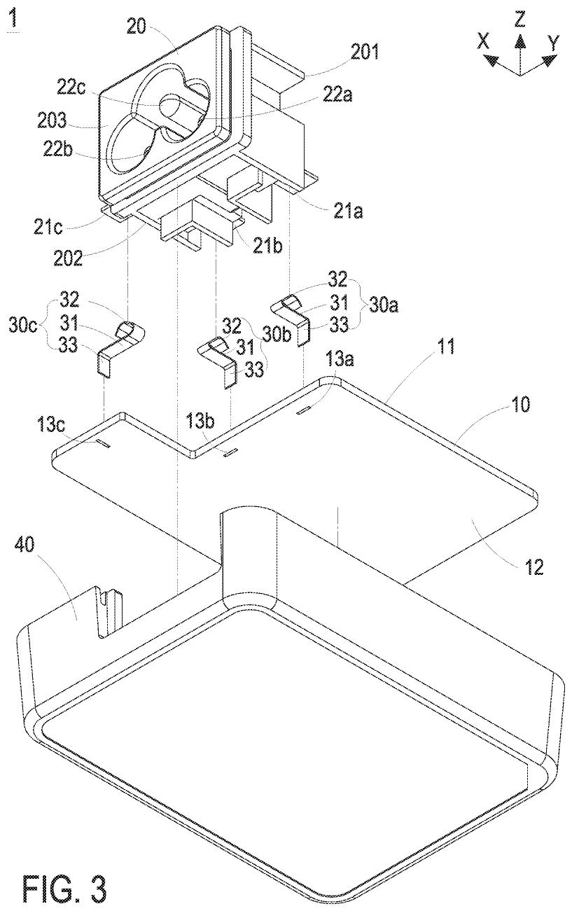

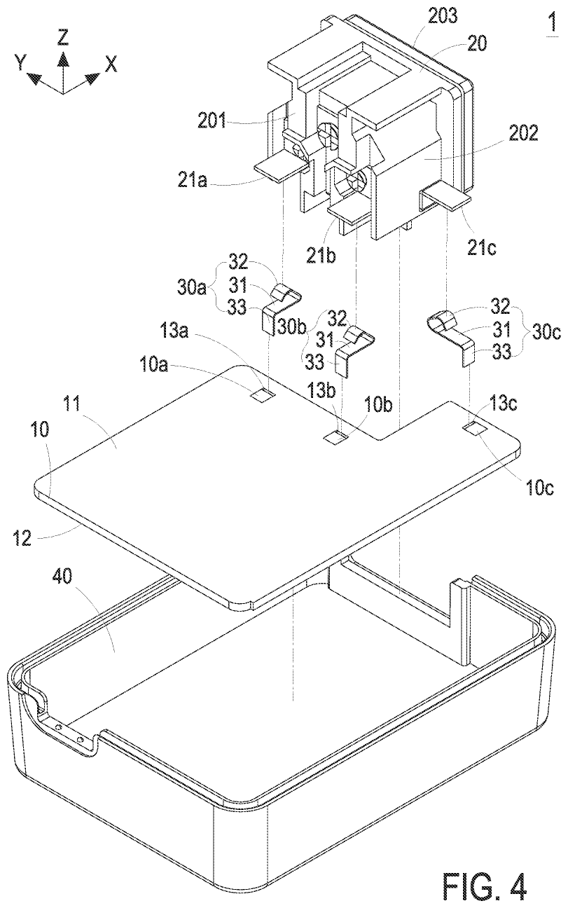

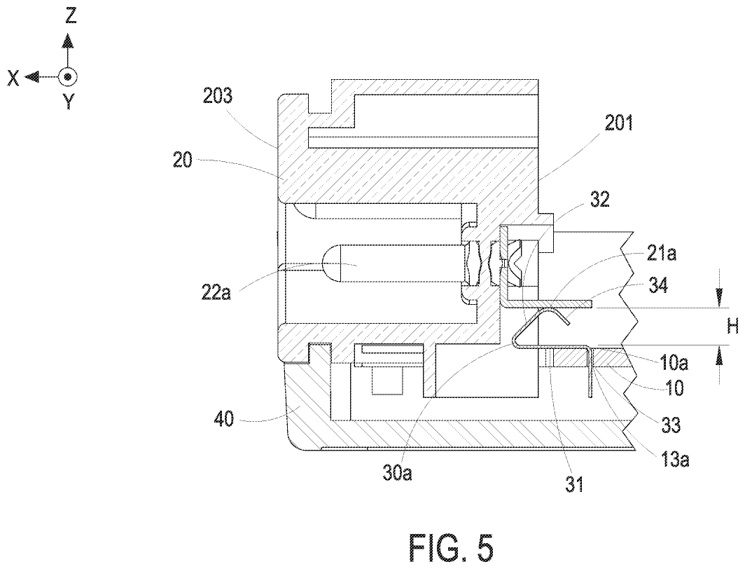

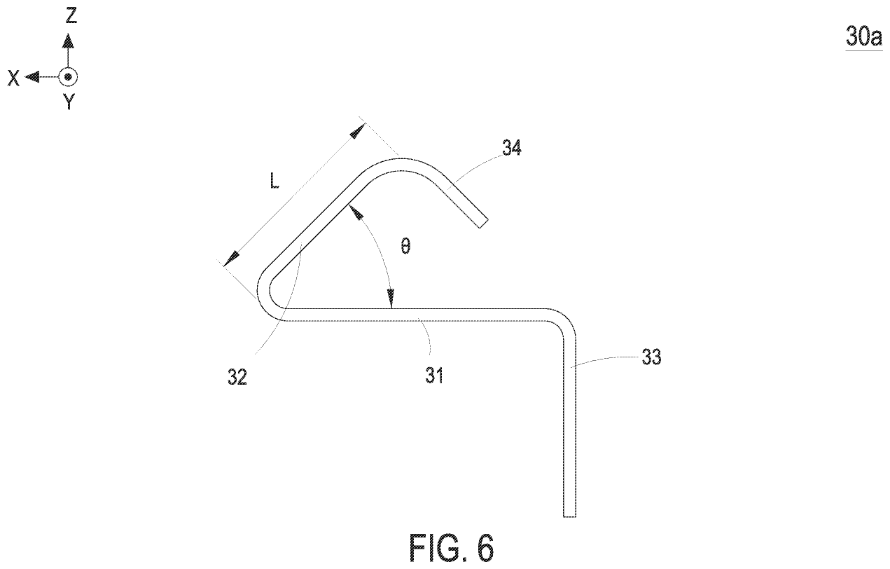

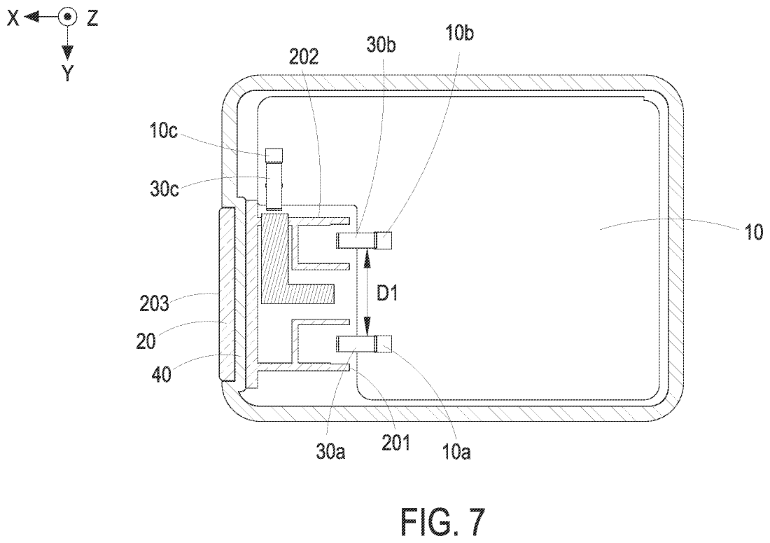

FIGS. 1 and 2 are perspective views illustrating a power adapter assembly structure according to a first embodiment of the present disclosure. FIGS. 3 and 4 are exploded views illustrating the power adapter assembly structure according to the first embodiment of the present disclosure. FIG. 5 is a vertical cross-sectional view illustrating the power adapter assembly structure according to the first embodiment of the present disclosure. FIG. 6 is an exemplary structural view illustrating the elastic element of the power adapter assembly structure according to the first embodiment of the present disclosure. FIG. 7 is a horizontal cross-sectional view illustrating the power adapter assembly structure according to the first embodiment of the present disclosure. In the embodiment, the power adapter assembly structure 1 includes a circuit board 10, a socket 20 and at least one elastic element. Preferably but not exclusively, the at least one elastic element is any one of a first elastic element 30a, a second elastic element 30b and a third elastic element 30c. Preferably but not exclusively, the socket 20 and the circuit board 10 are fixed on a housing 40, and the socket 20 is disposed adjacent to the circuit board 10. In the embodiment, when the circuit board 10 and the socket 20 are fixed on the housing 40, the circuit board 10 and the socket 20 are configured to collaboratively form at least one abutting surface and at least one fixing surface. Preferably but not exclusively, in the embodiment, the at least one abutting surface includes a live-wire abutting surface 21a, a neutral-wire abutting surface 21b and an earth-wire abutting surface 21c. The live-wire abutting surface 21a and the neutral-wire abutting surface 21b are disposed adjacent to a first side 201 of the socket 20, and the earth-wire abutting surface 21c is disposed adjacent to a second side 202 of the socket 20. Preferably but not exclusively, the at least one fixing surface includes a live-wire fixing surface 10a, a neutral-wire fixing surface 10b and an earth-wire fixing surface 10c, which are disposed on a top surface 11 of the circuit board 10. The first elastic element 30a, the second elastic element 30b and the third elastic element 30c are connected between the circuit board 10 and the socket 20, respectively. In the embodiment, the first elastic element 30a, the second elastic element 30b and the third elastic element 30c have the same or similar structure, and each of which includes a main body 31, a fixed portion 33 and a hanging arm 32. The fixed portion 33 and the hanging arm 32 are disposed at two opposite ends of the main body 31. The fixed portion 33 of the first elastic element 30a spatially corresponds to the live-wire fixing surface 10a, and the hanging arm 32 of the first elastic element 30a constantly abuts the live-wire abutting surface 21a. The fixed portion 33 of the second elastic element 30b spatially corresponds to the neutral-wire fixing surface 10b, and the hanging arm 32 of the second elastic element 30b constantly abuts the neutral-wire abutting surface 21b. The fixed portion 33 of the third elastic element 30c spatially corresponds to the earth-wire fixing surface 10c, and the hanging arm 32 of the third elastic element 30c constantly abuts the earth-wire abutting surface 21c. It should be noted that the corresponding relationships of the first elastic element 30a, the second elastic element 30b, and the third elastic element 30c connected between the circuit board 10 and the socket 20 are merely illustrative. Taking the first elastic element 30a as an example for illustration, a height H is formed between the main body 31 of the first elastic element 30a and the corresponding live-wire abutting surface 21a, as shown in FIG. 5. In addition, the hanging arm 32 of the first elastic element 30a is extended from the main body 31 to form a length L of the hanging arm 32, as shown in FIG. 6. In the embodiment, the height H is less than the length L of the hanging arm 32. In that, when the socket 20 and the circuit board 10 are fixed to the housing 40, the hanging arm 32 of the first elastic element 30a is pressed to generate an elastic force against the corresponding live-wire abutting surface 21a. The second elastic element 30b and the third elastic element 30c are also connected between the circuit board 10 and the socket 20 in the same manner.

Preferably but not exclusively, in the embodiment, each of the first elastic element 30a, the second elastic element 30b and the third elastic element 30c is integrally formed into one piece by a conductive metal sheet. The first elastic element 30a is connected between the live-wire fixing surface 10a of the circuit board 10 and the live-wire abutting surface 21a of the socket 20. The second elastic element 30b is connected between the neutral-wire fixing surface 10b of the circuit board 10 and the neutral abutting surface 21b of the socket 20. The third elastic element 30c is connected between the earth-wire fixing surface 10c of the circuit board 10 and the earth-wire abutting surface 21c of the socket 20. Whereby, a stable electrical connection between the socket 20 and the circuit board 10 is achieved. The first elastic element 30a is taken as the example for illustration. When the circuit board 10 and the socket 20 are fixed to the housing 40, the hanging arm 32 of the first elastic element 30a is pressed by the socket 20 and the circuit board 10 during assembling, and an elastic force is generated to constantly abut the corresponding live-wire abutting surface 21a. Therefore, the installation procedure of the first elastic element 30a, the second elastic element 30b and the third elastic element 30c is combined with the assembling procedure of the socket 20 and the circuit board 10, so as to realize the power adapter assembly structure 1 of the socket 20, the circuit board 10, the first elastic element 30a, the second elastic element 30b and the third elastic element 30c by the automatic assembling equipment, and ensure the electrical connection between the socket 20 and the circuit board 10.

Moreover, in the embodiment, taking the first elastic element 30a as the example for illustration, the hanging arm 32 and the main body 31 form an included angle θ. Preferably but not exclusively, the included angle θ is an acute angle ranged from 1° to 89°, so as to provide the elastic force and increase the structural strength. It is helpful to combine the assembling procedure of the socket 20 and the circuit board 10 to realize the power adapter assembly structure 1. In the embodiment, the first elastic element 30a further includes an extension section 34, which is connected to the hanging arm 32 and extended from the corresponding live-wire abutting surface 21a toward the main body 31, so as to facilitate the hanging arm 32 to firmly abut against the live-wire abutting surface 21a and increase the structural strength of the first elastic element 30a. Certainly, the present disclosure is not limited thereto. In the embodiment, the circuit board 10 includes at least one perforation 13a, 13b, 13c. Preferably but not exclusively, the fixed portion 33 of the first elastic element 30a is fixed to the circuit board 10 through the perforation 13a, and is electrically connected to the live-wire fixing surface 10a. The fixed portion 33 of the second elastic element 30b is fixed to the circuit board 10 through the perforation 13b, and is electrically connected to the neutral-wire fixing surface 10b. The fixed portion 33 of the third elastic element 30c is fixed to the circuit board 10 through the perforation 13c, and is electrically connected to the earth-wire fixing surface 10c. The length, the shape and the angle of the fixed portion 33 relative to the main body 31 are adjustable according to the practical requirements. Preferably but not exclusively, the fixed portion 33 is fixed to the circuit board 10 by welding. In the embodiment, the live-wire fixing surface 10a, the neutral-wire fixing surface 10b and the earth-wire fixing surface 10c are located on the top surface 11 of the circuit board 10, and are connected to the corresponding fixed portions 33 by welding, respectively. Preferably but not exclusively, in other embodiments, the live-wire fixing surface 10a, the neutral-wire fixing surface 10b, and the earth-wire fixing surface 10c are located on the bottom surface 12 of the circuit board 10, and are connected to the corresponding fixed portions 33 by welding, respectively. The present disclosure is not limited thereto.

In the embodiment, the live-wire fixing surface 21a and the neutral-wire fixing surface 21b of the socket 20 are located at the first side 201 of the socket 20. Preferably but not exclusively, the first side 201 is the rear side. The earth-wire fixing surface 21c of the socket 20 is located at the second side 202 of the socket 20. Preferably but not exclusively, the second side 202 is the lateral side. In the embodiment, the first elastic element 30a connected to the live-wire abutting surface 21a and the second elastic element 30b connected to the neutral-wire abutting surface 21b are led out from the first side 201 of the socket 20 and arranged in parallel to the X-axis direction. A minimum distance D1 is maintained between the first elastic element 30a and the second elastic element 30b, so as to ensure that the minimum distance D1 maintained between the first elastic element 30a and the second elastic element 30b meets the safety requirements for electrical clearance and creepage distance. Moreover, in the embodiment, the third elastic element 30c connected to the earth-wire abutting surface 21c is led out from the second side 202 of the socket 20 and arranged along the Y-axis direction. The main body 31 of the first elastic element 30a, the main body 31 of the second elastic element 30b, and the main body 31 of the third elastic element 30c are spaced apart from each other, to further ensure that the first elastic element 30a, the second elastic element 30b and the third elastic element 30c meet the safety requirements of electrical clearance and creepage distance. It avoids electrical EMI/RFI interference caused by crossed wires. In the embodiment, each of the live-wire abutting surface 21a, the neutral-wire abutting surface 21b and the earth-wire abutting surface 21c is formed by a conductive metal sheet. The socket 20 further includes three conductive pins. Preferably but not exclusively, the three conductive pins include a live-wire pin 22a, a neutral-wire pin 22b and an earth-wire pin 22c extended from the first side 201 to a third side 203 opposite to the first side 201, along the X-axis direction. Preferably but not exclusively, the live-wire pin 22a, the neutral-wire pin 22b, and the earth-wire pin 22c are electrically connected to the conductive metal sheets of the live-wire abutting surface 21a, the neutral-wire abutting surface 21b, and the earth-wire abutting surface 21c by riveting, respectively.

In the embodiment, the first elastic element 30a, the second elastic element 30b, and the third elastic element 30c are pre-fixed to the circuit board 10 through the fixing portions 33 thereof, respectively. When the circuit board 10 and the socket 20 are fixed to the housing 40, the live-wire abutting surface 21a, the neutral-wire abutting surface 21b and the earth-wire abutting surface 21c of the socket 20 push the hanging arms 32 of the first elastic element 30a, the second elastic element 30b and the third elastic element 30c, respectively, in the Z-axis direction, so as to complete the assembling procedure of the power adapter assembly structure 1. Since the electrical connection between the socket 20 and the circuit board 10 is achieved through the first elastic element 30a, the second elastic element 30b and the third elastic element 30c with structural strength, combined with the assembling procedure of the socket 20 and the circuit board 10, it is more helpful to realize the power adapter assembly structure 1 of the socket 20, the circuit board 10, the first elastic element 30a, the second elastic element 30b and the third elastic element 30c by an automated production method. The assembling procedure is simplified, the production cost is reduced, and the competitiveness of the product is enhanced.

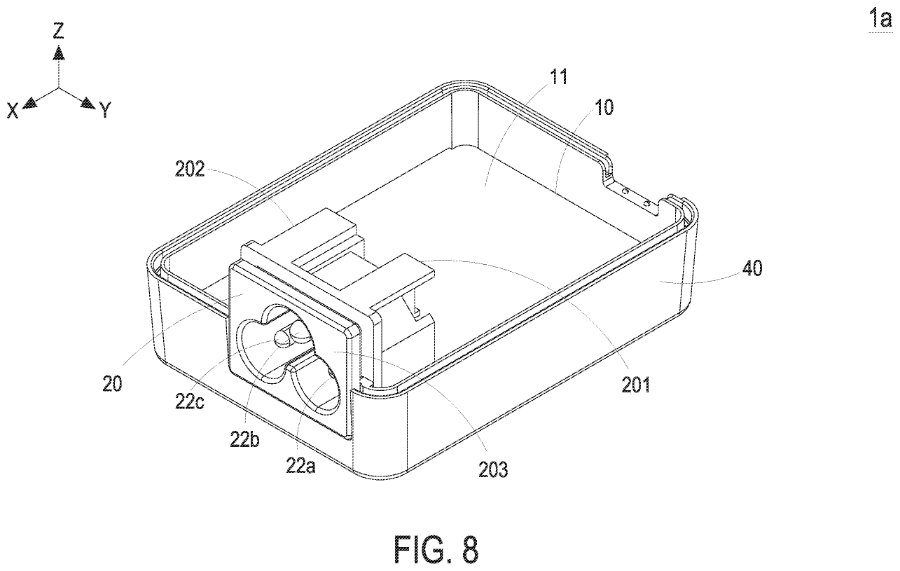

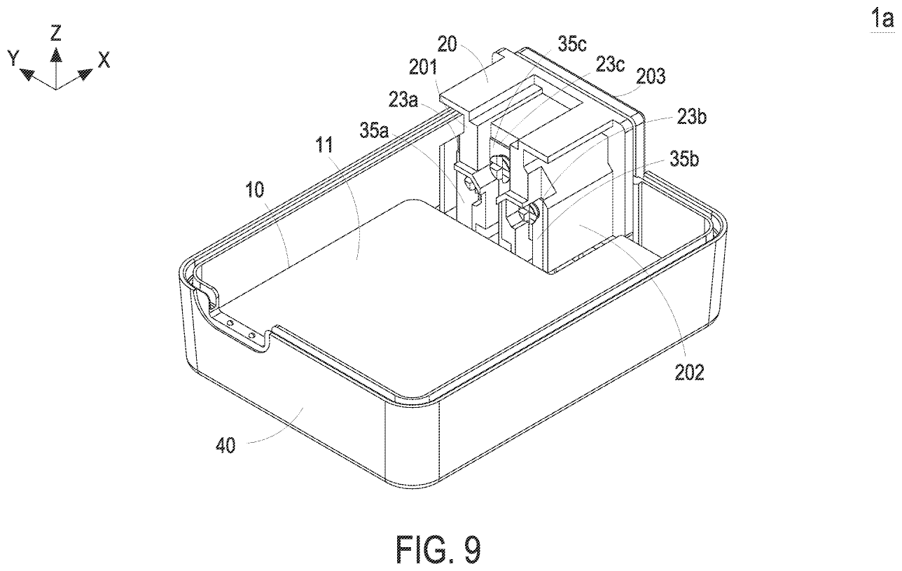

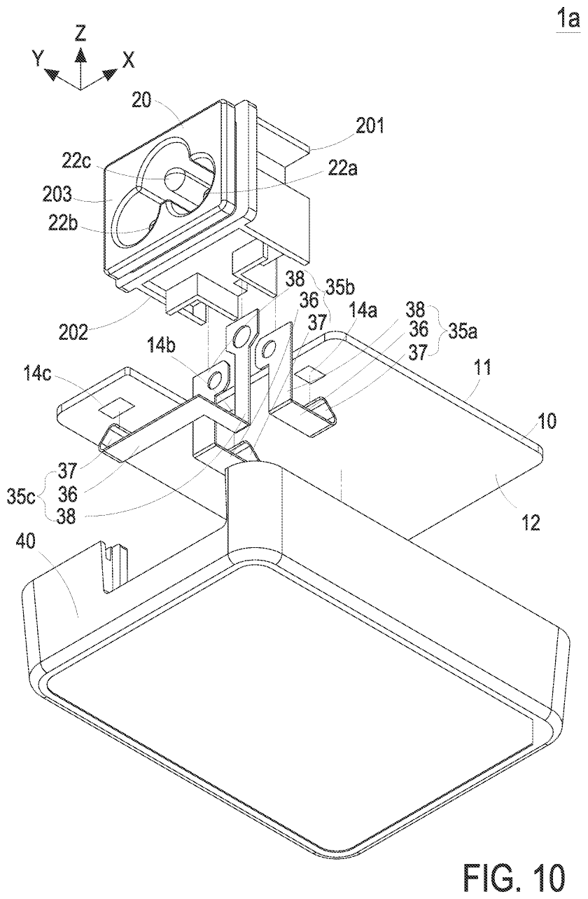

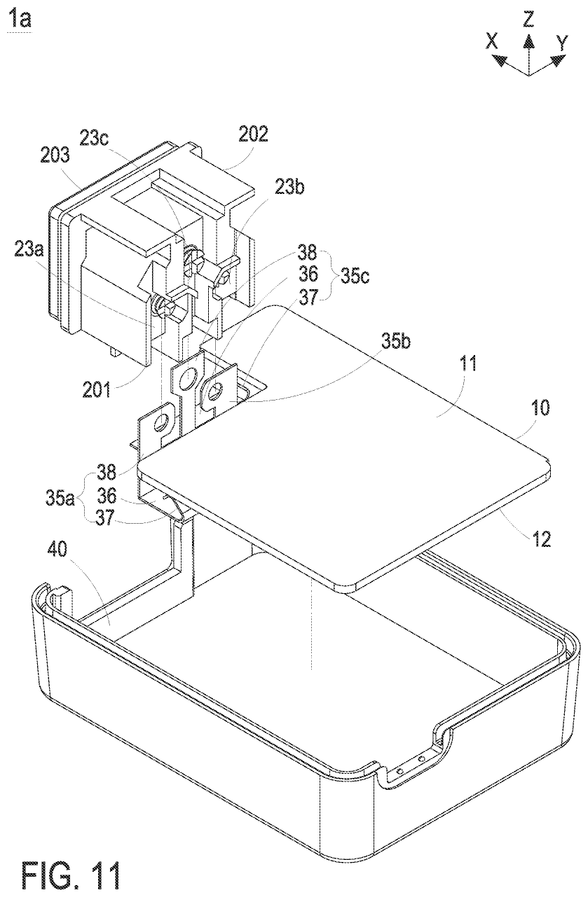

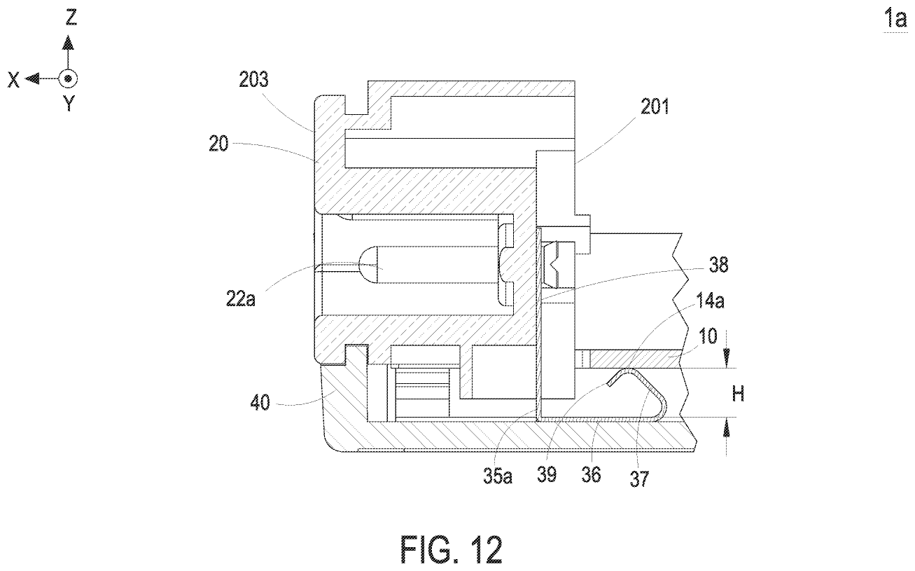

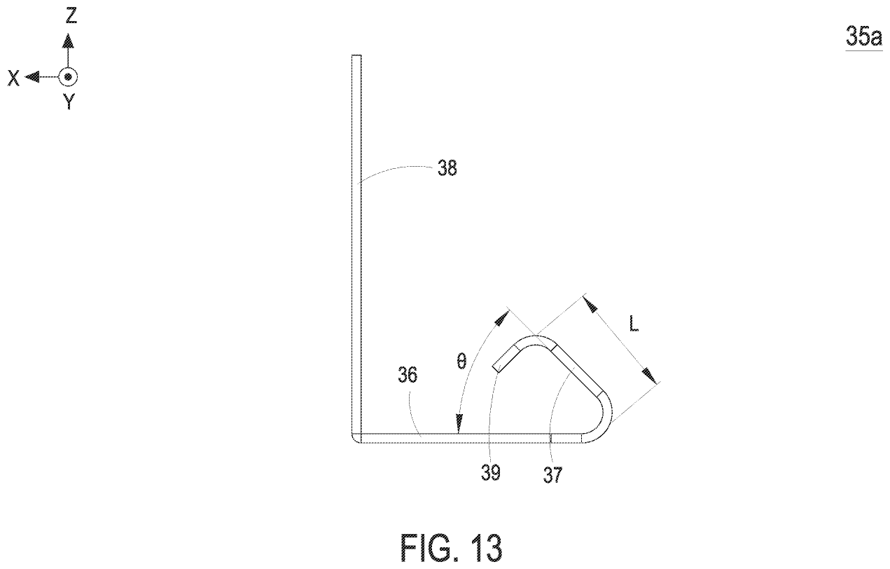

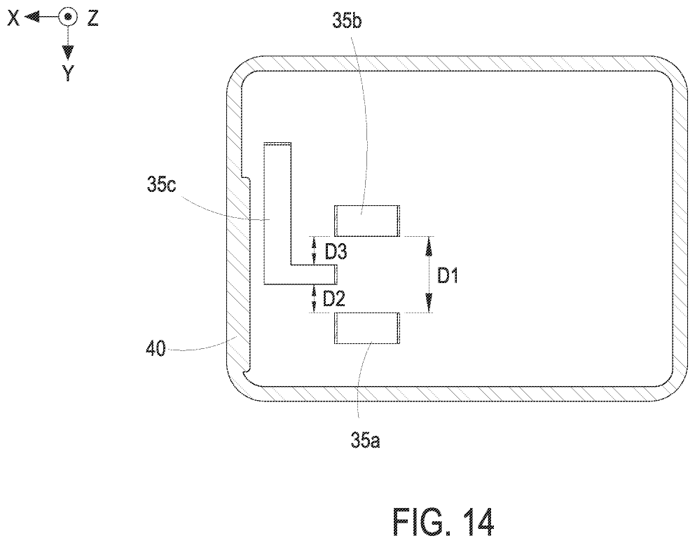

FIGS. 8 and 9 are perspective views illustrating a power adapter assembly structure according to a second embodiment of the present disclosure. FIGS. 10 and 11 are exploded views illustrating the power adapter assembly structure according to the second embodiment of the present disclosure. FIG. 12 is a vertical cross-sectional view illustrating the power adapter assembly structure according to the second embodiment of the present disclosure. FIG. 13 is an exemplary structural view illustrating the elastic element of the power adapter assembly structure according to the second embodiment of the present disclosure. FIG. 14 is a horizontal cross-sectional view illustrating the power adapter assembly structure according to the first embodiment of the present disclosure. In the embodiment, the structures, elements and functions of the power adapter assembly structure 1a are similar to those of the power adapter assembly structure 1 of FIGS. 1 to 7, and are not redundantly described herein. In the embodiment, the power adapter assembly structure 1a includes a circuit board 10, a socket 20, a first elastic element 35a, a second elastic element 35b and a third elastic element 35c. The socket 20 and the circuit board 10 are fixed on a housing 40, and the socket 20 is disposed adjacent to the circuit board 10. In the embodiment, when the circuit board 10 and the socket 20 are fixed on the housing 40, the circuit board 10 and the socket 20 are configured to collaboratively form at least one abutting surface and at least one fixing surface. Preferably but not exclusively, in the embodiment, the at least one abutting surface includes a live-wire abutting surface 14a, a neutral-wire abutting surface 14b and an earth-wire abutting surface 14c, which are disposed on the bottom surface 12 of the circuit board 10. Preferably but not exclusively, the at least one fixing surface includes a live-wire fixing surface 23a, a neutral-wire fixing surface 23b and an earth-wire fixing surface 23c, which are disposed on the first side 201 of the socket 20. The first elastic element 35a, the second elastic element 35b and the third elastic element 35c are connected between the circuit board 10 and the socket 20, respectively. In the embodiment, the first elastic element 35a, the second elastic element 35b and the third elastic element 35c have the same or similar structure, and each of which includes a main body 36, a fixed portion 38 and a hanging arm 37. The fixed portion 38 and the hanging arm 37 are disposed at two opposite ends of the main body 36. The fixed portion 38 of the first elastic element 35a spatially corresponds to the live-wire fixing surface 23a, and the hanging arm 37 of the first elastic element 35a constantly abuts the live-wire abutting surface 14a. The fixed portion 38 of the second elastic element 35b spatially corresponds to the neutral-wire fixing surface 23b, and the hanging arm 37 of the second elastic element 35b constantly abuts the neutral-wire abutting surface 14bb. The fixed portion 38 of the third elastic element 35c spatially corresponds to the earth-wire fixing surface 23c, and the hanging arm 37 of the third elastic element 35c constantly abuts the earth-wire abutting surface 14c. It should be noted that the corresponding relationships of the first elastic element 35a, the second elastic element 35b, and the third elastic element 35c connected between the circuit board 10 and the socket 20 are merely illustrative. Taking the first elastic element 35a as an example for illustration, a height H is formed between the main body 36 of the first elastic element 35a and the corresponding live-wire abutting surface 14a, as shown in FIG. 12. In addition, the hanging arm 37 of the first elastic element 35a is extended from the main body 36 to form a length L of the hanging arm 37, as shown in FIG. 13. In the embodiment, the height H is less than the length L of the hanging arm 37. In that, when the socket 20 and the circuit board 10 are fixed to the housing 40, the hanging arm 37 of the first elastic element 35a is pressed to generate an elastic force against the corresponding live-wire abutting surface 14a. The second elastic element 35b and the third elastic element 35c are also connected between the circuit board 10 and the socket 20 in the same manner.

Preferably but not exclusively, in the embodiment, each of the first elastic element 35a, the second elastic element 35b and the third elastic element 35c is integrally formed into one piece by a conductive metal sheet. The first elastic element 35a is connected between the live-wire abutting surface 14a of the circuit board 10 and the live-wire fixing surface 23a of the socket 20. The second elastic element 35b is connected between the neutral-wire abutting surface 14b of the circuit board 10 and the neutral fixing surface 23b of the socket 20. The third elastic element 35c is connected between the earth-wire abutting surface 14c of the circuit board 10 and the earth-wire fixing surface 23c of the socket 20. Whereby, a stable electrical connection between the socket 20 and the circuit board 10 is achieved. The first elastic element 35a is taken as the example for illustration. The first elastic element 35a is pre-fixed on the socket 20. When the circuit board 10 and the socket 20 are fixed to the housing 40, the hanging arm 37 of the first elastic element 35a is pressed by the circuit board 10 during assembling, and an elastic force is generated to constantly abut the corresponding live-wire abutting surface 14a. Therefore, the first elastic element 35a, the second elastic element 35b and the third elastic element 35c are pre-fixed on the socket 20 and combined with the assembling procedure of the socket 20 and the circuit board 10, so as to realize the power adapter assembly structure 1a of the socket 20, the circuit board 10, the first elastic element 35a, the second elastic element 35b and the third elastic element 35c by the automatic assembling equipment, and ensure the electrical connection between the socket 20 and the circuit board 10.

In the embodiment, taking the first elastic element 35a as the example for illustration, the hanging arm 37 and the main body 36 form an included angle θ. Preferably but not exclusively, the included angle θ is an acute angle ranged from 1° to 89°, so as to provide the elastic force and increase the structural strength. It is helpful to combine the assembling procedure of the socket 20 and the circuit board 10 to realize the power adapter assembly structure 1a. In the embodiment, the first elastic element 35a further includes an extension section 39, which is connected to the hanging arm 37 and extended from the corresponding live-wire abutting surface 14a toward the main body 36, so as to facilitate the hanging arm 37 to firmly abut against the live-wire abutting surface 14a and increase the structural strength of the first elastic element 35a. Certainly, the present disclosure is not limited thereto. The socket 20 further includes three conductive pins. Preferably but not exclusively, the three conductive pins include a live-wire pin 22a, a neutral-wire pin 22b and an earth-wire pin 22c extended from the first side 201 to the third side 203 opposite to the first side 201, along the X-axis direction. The live-wire pin 22a, the live-wire fixing surface 23a and the fixed portion 38 of the first elastic element 35a are electrically connected by riveting. The neutral-wire pin 22b, the neutral-wire fixing surface 23b and the fixed portion 38 of the second elastic element 35b are electrically connected by riveting. The earth-wire pin 22c, the earth-wire fixing surface 23c and the fixed portion 38 of the first elastic element 35c are electrically connected by riveting. In other words, the first elastic element 35a, the second elastic element 35b and the third elastic element 35c are pre-fixed on the socket 20. In the embodiment, the first elastic element 35a and the second elastic element 35b are arranged in parallel to the X-axis direction. A minimum distance D1 is maintained between the first elastic element 35a and the second elastic element 35b, so as to ensure that the minimum distance D1 maintained between the first elastic element 35a and the second elastic element 35b meets the safety requirements for electrical clearance and creepage distance. In addition, the third elastic element 35c is extended from the first side 201 of the socket 20 along the bottom of the socket 20 and is led out from the second side 202. The length or the shape of the main body 36 is not limited thereto. In the embodiment, the minimum distance D2 formed between the first elastic element 35a and the third elastic element 35c, and the minimum distance D3 formed between the second elastic element 35b and the third elastic element 35c meet the safety requirements of electrical clearance and creepage distance. Since the third elastic sheet 35c is passed through the socket 20 and led out from the second side 202 of the socket 20. In other embodiments, the electrical clearance and the creepage distance between the third elastic sheet 35c and the first elastic element 35a or the electrical clearance and the creepage distance between the third elastic sheet 35c and the second elastic element 35b is increased by the insulation structure design of the socket 20. The present disclosure is not limited thereto, and not redundantly described hereafter.

In summary, the present disclosure provides a power adapter assembly structure. By utilizing the elastic element to connect the socket and the circuit board, the assembling procedure is simplified, the automated production is realized, and the EMI/RFI caused by the crossed leading wires is avoided at the same time. With one-piece formed elastic element connected between a fixing surface and an abutting surface formed by the socket and the circuit board, a stable electronical connection of the socket and the circuit board are achieved. When the elastic element is pressed against the corresponding abutting surface constantly through the hanging arm thereof, the included angle between the hanging arm and the main body is for example an acute angle, so as to provide the elastic force and increase the structural strength. Since the hanging arm of the elastic element is pressed to constantly abut the corresponding abutting surface by the elastic force generated during assembling the socket and the circuit board, the assembling procedure of the socket and the circuit board is combined to realize the assembly structure of the socket, the circuit board and the elastic element by the automatic assembling equipment, and ensure the electrical connection between the socket and the circuit board. The elastic elements are configured to form the electrical connections between the socket and the circuit board, which are for example connected to the live wire, the neutral wire and the earth wire. Two elastic elements connected to the live wire and the neutral wire are led out from the rear side of the socket and arranged in parallel, so as to ensure that the minimum distance maintained between the two elastic elements meets the safety requirements for electrical clearance and creepage distance. In addition, the elastic element connected to the earth wire is led out from the lateral side of the socket to further ensure that the three elastic elements meet the safety requirements of electrical clearance and creepage distance. It avoids electrical EMI/RFI interference caused by crossed wires. On the other hand, since the electrical connections between the socket and the circuit board are realized through the elastic elements with structural strength, and integrated with the assembling procedure of the socket and the circuit board, it is more helpful to realize the assembly structure of the socket, the circuit board and the elastic elements by an automated production method. The assembling procedure is simplified, the production cost is reduced, and the competitiveness of the product is enhanced.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power adapter assembly structure, comprising:
a circuit board;
a socket disposed adjacent to the circuit board, wherein the circuit board and the socket are configured to collaboratively form at least one abutting surface and at least one fixing surface; and
at least one elastic element connected between the circuit board and the socket, and comprising a main body, a fixed portion and a hanging arm, wherein the fixed portion and the hanging arm are disposed at two opposite ends of the main body, the fixed portion of the at least one elastic element spatially corresponds to the at least one fixing surface, and the hanging arm of the at least one elastic element constantly abuts the at least one abutting surface, wherein a height is formed between the main body of the at least one elastic element and the at least one abutting surface, and the height is less than a length of the hanging arm extended from the main body.

2. The power adapter assembly structure according to claim 1, further comprising a housing, wherein the circuit board and the socket are fastened on the housing, the at least one abutting surface is located at the socket, and the at least one fixing surface is located at the circuit board.

3. The power adapter assembly structure according to claim 2, wherein the at least one abutting surface comprises a live-wire abutting surface and a neutral-wire abutting surface located at a first side of the socket, and the at least one elastic element comprises a first elastic element and a second elastic element, wherein the hanging arm of the first elastic element constantly abuts the live-wire abutting surface, and the hanging arm of the second elastic element constantly abuts against the neutral-wire abutting surface.

4. The power adapter assembly structure according to claim 3, wherein the at least one fixing surface comprises a live-wire fixing surface and a neutral-wire fixing surface located at a surface of the circuit board, and the fixed portion of the first elastic element is connected to the live-wire fixing surface, and the fixed portion of the second elastic element is connected to the neutral-wire fixing surface, wherein the first elastic element and the second elastic element are arranged parallel to each other.

5. The power adapter assembly structure according to claim 4, wherein the at least one abutting surface further comprises an earth-wire abutting surface located at a second side of the socket, and the at least one elastic element further comprises a third elastic element, wherein the hanging arm of the third elastic element constantly abuts against the earth-wire abutting surface.

6. The power adapter assembly structure according to claim 5, wherein the at least one fixing surface further comprises an earth-wire fixing surface located at the surface of the circuit board, and the fixed portion of the third elastic element is connected to the earth-wire fixing surface.

7. The power adapter assembly structure according to claim 5, wherein each of the live-wire abutting surface, the neutral-wire abutting surface and the earth-wire abutting surface is formed by a conductive metal sheet, wherein the socket further comprises three conductive pins extended from the first side to a third side opposite to the first side, and the live-wire abutting surface, the neutral-wire abutting surface and the earth-wire abutting surface are electrically connected to the three conductive pins, respectively.

8. The power adapter assembly structure according to claim 2, wherein the circuit board comprises at least one perforation, and the fixed portion of the at least one elastic element is fixed on the circuit board through the perforation and electrically connected to the at least one fixing surface corresponding thereto.

9. The power adapter assembly structure according to claim 1, further comprising a housing, wherein the circuit board and the socket are fastened on the housing, the at least one abutting surface is located at the circuit board, and the at least one fixing surface is located at the socket.

10. The power adapter assembly structure according to claim 9, wherein the at least one abutting surface comprises a live-wire abutting surface and a neutral-wire abutting surface located at a surface of the circuit board, and the at least one elastic element comprises a first elastic element and a second elastic element, wherein the hanging arm of the first elastic element constantly abuts the live-wire abutting surface, and the hanging arm of the second elastic element constantly abuts against the neutral-wire abutting surface.

11. The power adapter assembly structure according to claim 10, wherein the at least one fixing surface comprises a live-wire fixing surface and a neutral-wire fixing surface located at a first side of the socket, and the fixed portion of the first elastic element is connected to the live-wire fixing surface, and the fixed portion of the second elastic element is connected to the neutral-wire fixing surface, wherein the first elastic element and the second elastic element are arranged parallel to each other.

12. The power adapter assembly structure according to claim 11, wherein the at least one abutting surface further comprises an earth-wire abutting surface located at the surface of the circuit board, and the at least one elastic element further comprises a third elastic element, wherein the hanging arm of the third elastic element constantly abuts against the earth-wire abutting surface.

13. The power adapter assembly structure according to claim 12, wherein the at least one fixing surface further comprises an earth-wire fixing surface located at the first side of the socket, and the fixed portion of the third elastic element is connected to the earth-wire fixing surface.

14. The power adapter assembly structure according to claim 13, wherein the main body of the third elastic element is extended from the first side to a second side, wherein the main body of the third elastic element, the main body of the second elastic element and the main body of the third elastic element are spaced apart from each other.

15. The power adapter assembly structure according to claim 13, wherein the socket further comprises three conductive pins extended from the first side to a third side opposite to the first side, and the live-wire fixing surface, the neutral-wire fixing surface and the earth-wire fixing surface are electrically connected to the three conductive pins, respectively.

16. The power adapter assembly structure according to claim 1, wherein the hanging arm and the main body form an included angle, and the included angle is an acute angle.

17. The power adapter assembly structure according to claim 1, wherein the at least one elastic element further comprises an extension section connected to the hanging arm, and extended from the corresponding one of the at least one abutting surface toward the main body.
